(19) United States
(12) Patent Application Publication
(10) Pub. No.: US 2026/0066205 A1
(43) Pub. Date: Mar. 5, 2026

(54) HIGH VOLTAGE BATTERY SYSTEM CONTACTOR CONTROL

(71) Applicant: FCA US LLC, Auburn Hills, MI (US)

(72) Inventors: Rudolf Kharpuri, Auburn Hills, MI (US); Abhilash Gudapati, Auburn Hills, MI (US)

(21) Appl. No.: 18/821,336

(22) Filed: Aug. 30, 2024

(51) Int. Cl. H01H 47/22; B60L 50/60

(52) U.S. Cl. CPC H01H 47/22; B60L 50/60; B60L 2240/80; B60L 2270/142

(57) ABSTRACT

An electrified vehicle includes an electrified powertrain, a high voltage (HV) battery system, and one or more contactors configured to selectively connect the HV battery system to a HV bus, the one or more contactors producing a contactor noise when opened. An entertainment module is configured to generate audio sound. A controller is programmed to detect an ignition of the vehicle is keyed OFF, initiate a contactor opening sequence with a change of mind timer configured to provide a predetermined time period for a driver to change their mind about keying OFF the vehicle before the one or more contactors are commanded open, determine if the generated audio sound is louder than the contactor noise, and command the one or more contactors to open if the generated audio sound is louder than the contactor noise and the change of mind timer has expired, to thereby mask the contactor noise.

### FIELD

The present application relates generally to high voltage electrified powertrain vehicles and, more particularly, to systems and methods to control high voltage contactor operations.

### BACKGROUND

In some electric vehicles, after a high voltage function is disabled, a supervisory controller commands contactors to open to perform shutdown functions. However, some contactors generate a loud and audible noise while opening, which may alarm or annoy a passenger, particularly if they have not exited the vehicle. Thus, while conventional systems do work well for their intended purpose, there remains a need for improvement in the relevant art.

### SUMMARY

In accordance with one example aspect of the invention, an electrified vehicle is provided. In one example implementation, the electrified vehicle includes an electrified powertrain configured to generate drive torque, a high voltage (HV) battery system for powering the electrified powertrain, and one or more contactors configured to selectively connect the HV battery system to a HV bus, the one or more contactors producing a contactor noise when opened to disconnect the HV battery system. An entertainment module is configured to generate audio sound. A control system includes a controller programmed to detect an ignition of the vehicle is keyed OFF, initiate a contactor opening sequence including initiating a change of mind timer configured to provide a predetermined time period for a driver to change their mind about keying OFF the vehicle before the one or more contactors are commanded open, monitor the entertainment module to determine if the generated audio sound is louder than the contactor noise, and command the one or more contactors to open if the generated audio sound is louder than the contactor noise and the change of mind timer has expired, to thereby mask the contactor noise as perceived by the driver.

In addition to the foregoing, the described vehicle may include one or more of the following features: wherein the contactor opening sequence is initiated only when the electrified vehicle does not require high voltage energy; and wherein the controller is further programmed to determine if the driver has exited the vehicle after the ignition is keyed OFF, and command the one or more contactors to open if the driver has exited the vehicle and the change of mind timer has expired.

In addition to the foregoing, the described vehicle may include one or more of the following features: wherein the controller is further programmed to determine the driver is still in the vehicle after the ignition is keyed OFF, identify a noise generating device that will begin a shutdown procedure that generates a device noise loud enough to mask the contactor noise, and command the one or more contactors to open when the identified noise generating device generates the device noise, to thereby mask the contactor noise as perceived by the driver; and wherein the noise generating device is one of an electronic climate control (ECC), the entertainment module, and an instrument panel cluster.

In accordance with another example aspect of the invention, an electrified vehicle is provided. In one example implementation, the electrified vehicle includes an electrified powertrain configured to generate drive torque, a high voltage (HV) battery system for powering the electrified powertrain, and one or more contactors configured to selectively connect the HV battery system to a HV bus, the one or more contactors producing a contactor noise when opened to disconnect the HV battery system. A noise generating device is configured to, upon shut down, generate a device noise. A control system includes a controller programmed to detect an ignition of the vehicle is keyed OFF, initiate a contactor opening sequence including initiating a change of mind timer configured to provide a predetermined time period for a driver to change their mind about keying OFF the vehicle before the one or more contactors are commanded open, determine the driver is still inside the vehicle after the ignition is keyed OFF, and command the one or more contactors to open when the driver is still inside the vehicle, the change of mind timer has expired, and the noise generating device generates the device noise, to thereby mask the contactor noise as perceived by the driver.

In addition to the foregoing, the described vehicle may include one or more of the following features: wherein the contactor opening sequence is initiated only when the electrified vehicle does not require high voltage energy; and wherein the controller is further programmed to determine if the driver has exited the vehicle after the ignition is keyed OFF, and command the one or more contactors to open if the driver has exited the vehicle and the change of mind timer has expired.

In addition to the foregoing, the described vehicle may include one or more of the following features: an entertainment module configured to generate audio sound, wherein the controller is further programmed to monitor the entertainment module to determine if the generated audio sound is louder than the contactor noise, and command the one or more contactors to open if the generated audio sound is louder than the contactor noise and the change of mind timer has expired, to thereby mask the contactor noise as perceived by the driver; and wherein the noise generating device is one of an electronic climate control (ECC), the entertainment module, and an instrument panel cluster.

In accordance with another example aspect of the invention, a method of reducing perceptible contactor noise generated by one or more contactors of an electrified vehicle is provided. The vehicle includes an electrified powertrain, a high voltage (HV) battery system selectively connected to a HV bus by the one or more contactors, and an entertainment module configured to generate audio sound.

In one example implementation, the method includes detecting, by a controller, an ignition of the vehicle is keyed OFF; initiating, by the controller, a contactor opening sequence including initiating a change of mind timer configured to provide a predetermined time period for a driver to change their mind about keying OFF the vehicle before the one or more contactors are commanded open; monitoring, by the controller, the entertainment module to determine if the generated audio sound is louder than the contactor noise; and commanding, by the controller, the one or more contactors to open if the generated audio sound is louder than the contactor noise and the change of mind timer has expired, to thereby mask the contactor noise as perceived by the driver.

In addition to the foregoing, the described method may include one or more of the following features: wherein the contactor opening sequence is initiated only when the electrified vehicle does not require high voltage energy; determining, by the controller, if the driver has exited the vehicle after the ignition is keyed OFF, and commanding, by the controller, the one or more contactors to open if the driver has exited the vehicle and the change of mind timer has expired.

In addition to the foregoing, the described method may include one or more of the following features: determining, by the controller, the driver is still in the vehicle after the ignition is keyed OFF; identifying, by the controller, a noise generating device that will begin a shutdown procedure that generates a device noise loud enough to mask the contactor noise; and commanding, by the controller, the one or more contactors to open when the identified noise generating device generates the device noise, to thereby mask the contactor noise as perceived by the driver; and wherein the noise generating device is one of an electronic climate control (ECC), the entertainment module, and an instrument

### PANEL CLUSTER.

Further areas of applicability of the teachings of the present application will become apparent from the detailed description, claims and the drawings. It should be understood that the detailed description, including disclosed embodiments and drawings referenced therein, are merely exemplary in nature intended for purposes of illustration only and are not intended to limit the scope of the present application, its application or uses. Thus, variations that do not depart from the gist of the present application are intended to be within the scope of the present application.

### BRIEF DESCRIPTION OF DRAWINGS

FIG. 1 is a functional block diagram of an electrified vehicle having a high voltage contactor control system, in accordance with the principles of the present disclosure;

FIG. 2 is a functional block diagram of an example architecture for the high voltage contactor control system, in accordance with the principles of the present disclosure; and

FIG. 3 illustrates a flow diagram of an example method of operating the electrified vehicle of FIG. 1 in accordance with the principles of the present disclosure.

### DESCRIPTION

As previously described, after a high voltage (HV) function is disabled in an electrified vehicle, a supervisory controller commands the HV contactors to open to perform shutdown functions. Example HV functions include key/ignition OFF, charging/discharging complete, HV conditioning, fuel cell after-run, 12V periodic charging, scheduled cabin conditioning or any HV function elapsed. However, opening the contactors may generate an unacceptable NVH that annoys or alarms a vehicle passenger. This noise may be particularly loud when the passenger is inside the vehicle, due to the location of the contactors on the battery pack, and may be more pronounced in vehicles with carbon fiber chassis/components.

Accordingly, described herein are systems and methods for mitigating the sound/effect caused by contactor opening. In one example, the system utilizes multiple masking mechanisms through acceptable noises when a passenger is inside the vehicle cabin, and then utilizes a passenger proximity detection mechanism to open the contactors. The system also provides a passenger change-of-mind operation to prevent unnecessary life cycle reducing contactor opening and closing sequences, for example, during a re-crank after keying off, key off and plug in for charging, plug-out after HV event and starting, enabling discharging functions, etc. The system is configured to maximize energy efficiency by not keeping the contactors closed, which can cause energy drain as the HV systems require energy to continue their intended functions (e.g., thermal system support, 12V support, etc.).

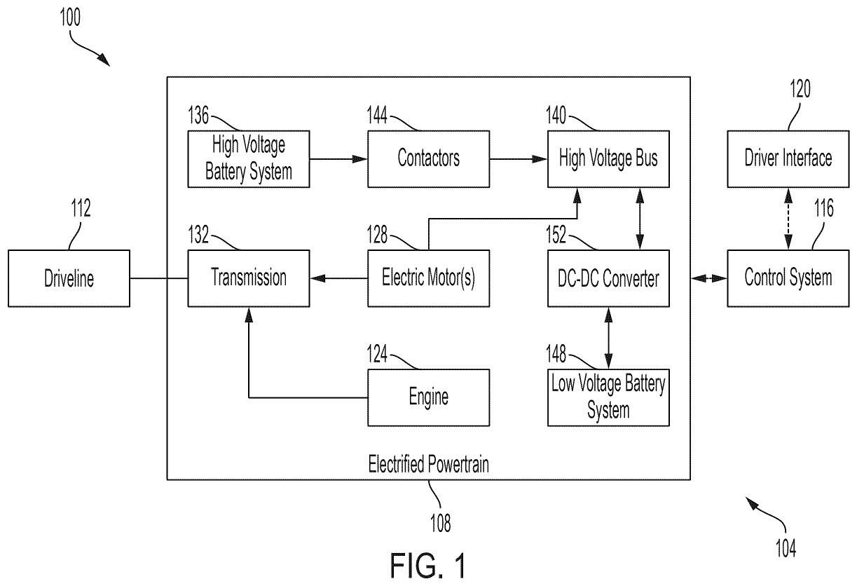

Referring now to FIG. 1, a functional block diagram of an electrified vehicle 100 having an example high voltage (HV) battery control system 104 according to the principles of the present application is illustrated. The vehicle 100 comprises an electrified powertrain 108 configured to generate and transfer drive torque to a driveline 112 for vehicle propulsion. A control system 116 is configured to control the electrified powertrain 108, such as to generate a desired amount of drive torque to satisfy a driver torque request received via a driver interface 120 (e.g., an accelerator pedal) and based on torque-related parameters. The electrified powertrain 108 comprises an optional internal combustion engine 124 configured to combust a mixture of air and fuel (e.g., gasoline) to generate drive torque at a crankshaft (not shown). The electrified powertrain 108 also comprises one or more electric motors 128 configured to, when operating as torque generators, generate drive torque using electrical energy from a high voltage battery system 136.

It will be appreciated that the electrified vehicle 100 could have any suitable powertrain configuration (e.g., BEV). The drive torque from the electric motor(s) 128 and the optional engine 124 is transferred to the driveline 112 via a transmission 132. The electrified powertrain 108 further comprises a low voltage (e.g., 12V) battery system 148 that is connected directly or via a DC-DC converter 152 to a high voltage bus 140, which is also electrically isolated from the high voltage battery system 136 by a set of contactors 144.

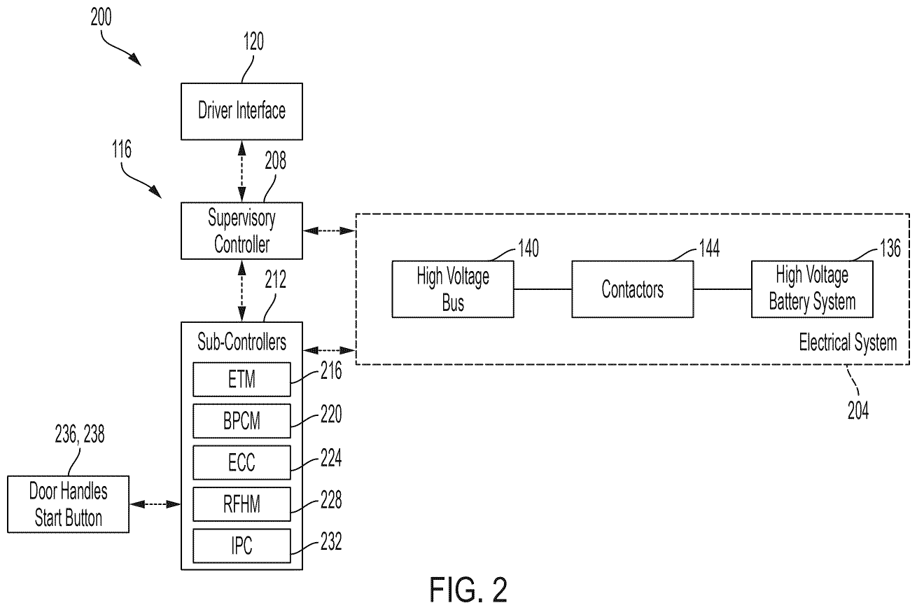

Referring now to FIG. 2, a functional block diagram of an example architecture 200 for the HV battery control system 104 according to the principles of the present application is illustrated. It will be appreciated that this is merely one exemplary configuration of the HV battery control system 104 and other implementations could be utilized. The architecture 200 illustrates a portion of a HV electrical system 204 of the vehicle 100, a supervisory controller 208 and one or more sub-controllers 212 that collectively form the control system 116.

In the example embodiment, the contactors 144 selectively establish an electrical connection between the HV battery system 136 and the HV bus 140. The supervisory controller 208 (e.g., an electric vehicle control unit, or EVCU) is configured to detect a request to perform a high voltage connection procedure where the high voltage battery system 136 that is disconnected by contactors 144 in an open state is subsequently connected to the high voltage bus 140. This request, for example only, could be a request for one of (i) powering the electric motor(s) 128 for vehicle propulsion, (ii) recharging the high voltage battery system 136, and (iii) thermal conditioning of the high voltage battery system 136 and/or a cabin environment of the vehicle 100.

The supervisory controller 208 is also configured to detect a request to perform a high voltage disconnection procedure (e.g., a contactor opening procedure) where the HV battery system 136 that is connected by contactors 144 in a closed state is subsequently disconnected from the HV bus 140. This request, for example only, could be a request for powering down the vehicle after the ignition is keyed OFF.

In the example implementation, the sub-controllers 212 include an entertainment module (ETM) 216, a battery pack control module (BPCM) 220, an electronic climate control (ECC) 224, a radio frequency hub module (RFHM) 228, and an instrument panel cluster (IPC) 232. The ETM 216 is an entertainment unit such as, for example, a radio or infotainment unit, which may include a touchscreen for user input. The ETM 216 is configured to generate an audio noise (e.g., music) in the vehicle cabin. The BPCM 220 is configured to close the one or more contactors 144 to selectively enable high voltage on the HV bus 140. The ECC 224 is configured to control one or more HVAC features for climate control within the vehicle cabin. The RFHM 228 generally includes one or more transmitters/transceivers and microcontrollers (not shown) to support monitoring of and signal communication with vehicle systems such as, for example, one or more door handles 236 and a vehicle start button 238, as well as a key fob device (not shown). The IPC 232 is configured to display various information to the driver. As described herein in more detail, one or more vehicle components, such as the ETM 216, ECC 224, and/or IPC 232, may be utilized as a non-propulsive noise generating component to mask noise generated when contactors 144 open.

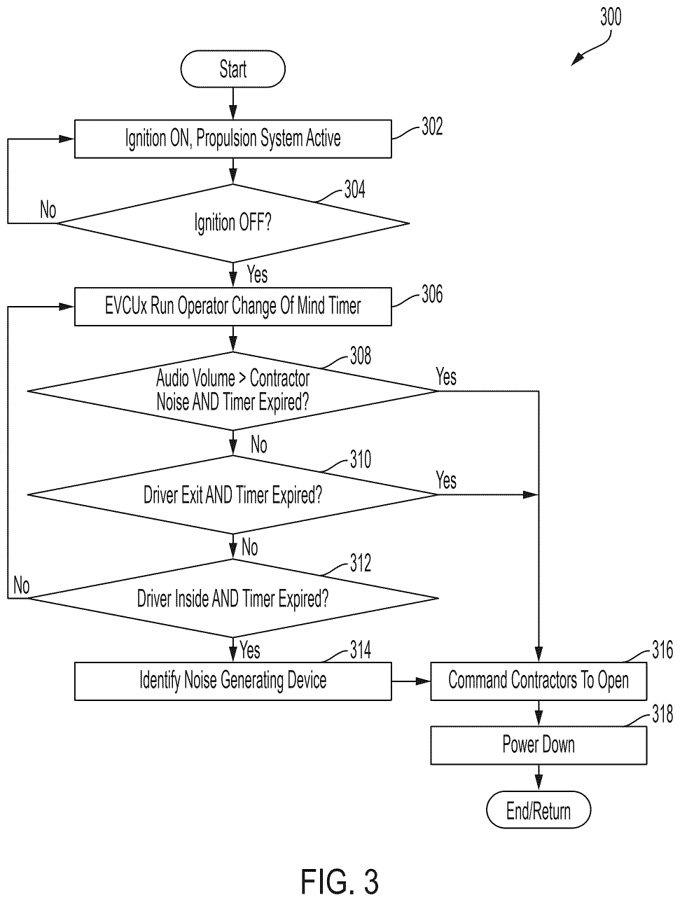

Referring now to FIG. 3, a flow diagram of an example method 300 of controlling the HV battery control system 104 of an electrified vehicle according to the principles of the present application is illustrated. While the components of vehicle 100 and FIGS. 1-2 are referenced for explanatory purposes, it will be appreciated that this method 300 could be applicable to any suitable electrified vehicle. The method begins at 302, with the vehicle 100 ignition ON and the propulsion system 108, 112 active. At 304, the supervisory controller 208 (“control”) determines if the vehicle ignition is turned OFF. If no, control returns to step 302. If yes, control proceeds to step 306.

At 306, control initiates a contactor opening sequence, including initiating an operator change of mind timer to provide a predetermined time period (e.g., ˜10 sec) for the operator to change their mind about keying OFF the vehicle before the contactors 144 are commanded open. This is configured to prevent opening and closing the contactors 144 multiple times, which reduces the life cycle of the contactors. In one example, the change of mind timer is implemented only when there is no other reason to keep the contactors 144 closed (e.g., no high voltage required) after a key off event. For example, the timer is not implemented during a thermal after-run, post cabin conditioning with Ignition OFF, fuel cell after run, etc.

At 308, control monitors the vehicle to determine if a vehicle audio volume level is greater than the noise generated by the opening of contactors 144 AND if the change of mind timer has expired. In one example, the audio volume is an audio generated by the ETM 216 (e.g., music/radio). The audio level may be measured in sones or decibels and the contactor noise sequence may be calibrated for a worst case contactor aging. Accordingly, if the vehicle audio volume level is great enough to mask the contactor opening noise AND the change of mind timer has expired, control proceeds to step 316 and opens contactors 144. If not, control proceeds to step 310.

At step 310, control determines if the driver has exited the vehicle AND if the change of mind timer has expired. In one example, control determines whether the driver has exited the vehicle based on proximity detection. This may be detected through multiple mechanisms, such as the RFHM 228 detecting the vehicle is locked from the outside with an authenticated device (e.g., key fob) or door handles 236 and the location of the authenticated device is in the proximity of the vehicle 100 or RFHM 228. Accordingly, if it is determined the driver/passengers have exited the vehicle AND the change of mind timer has expired, control proceeds to step 316 and opens contactors 144. If not, control proceeds to step 312.

At 312, control determines if the driver is inside the vehicle AND the change of mind timer has expired. The driver remaining inside the vehicle may be detected through multiple mechanisms, such as the ECC 224 indicating HVAC adjustment is in progress, seat sensors (not shown) indicating a passenger is seated within the vehicle, or that the vehicle door(s) have not opened. In one example, if the driver does not open the door, optional features such as ‘comfort enable’ (e.g., power supply to accessory functions) are available for a predetermined period (e.g., 45 sec to 10 min). By keeping the contactors 144 closed during this time, the low voltage battery system 148 is supported to ensure availability for the next key cycle or ignition off usage cycle. In some examples, the ‘comfort enable’ is connected to post cabin conditioning and additional accessories where HV is required to support the functionalities. As such, if the driver/passenger remains in the vehicle AND the change of mind timer has not expired, control returns to step 306 and initiates a new timer such as, for example, a new change of mind timer or ‘comfort enable’ timer. If the driver/passenger remains in the vehicle AND the change of mind timer has expired, control proceeds to step 314.

At step 314, control identifies a noise generating device that will begin a shutdown procedure that generates a noise loud enough to mask the sound of the contactors opening, and subsequently times the opening of the contactors 144 with the time the noise generating device generates the noise. The noise generating device includes the ETM 216, ECC 224, IPC 232, or any suitable vehicle component configured to generate a noise loud enough to mask the sound of the contactors opening. Control then proceeds to step 316 and opens the contactors 144 at the same time the noise generating device generates the masking noise. At 318, control then powers down the vehicle upon all functions have elapsed. Control then ends or returns to 302.

It will be appreciated that the term “controller” or “module” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electrified vehicle, comprising:
an electrified powertrain configured to generate drive torque;
a high voltage (HV) battery system for powering the electrified powertrain;
one or more contactors configured to selectively connect the HV battery system to a HV bus, the one or more contactors producing a contactor noise when opened to disconnect the HV battery system;
an entertainment module configured to generate audio sound; and
a control system including a controller programmed to:
detect an ignition of the vehicle is keyed OFF;
initiate a contactor opening sequence including initiating a change of mind timer configured to provide a predetermined time period for a driver to change their mind about keying OFF the vehicle before the one or more contactors are commanded open;
monitor the entertainment module to determine if the generated audio sound is louder than the contactor noise; and
command the one or more contactors to open if the generated audio sound is louder than the contactor noise and the change of mind timer has expired, to thereby mask the contactor noise as perceived by the driver.

2. The electrified vehicle of claim 1, wherein the contactor opening sequence is initiated only when the electrified vehicle does not require high voltage energy.

3. The electrified vehicle of claim 1, wherein the controller is further programmed to:
determine if the driver has exited the vehicle after the ignition is keyed OFF; and
command the one or more contactors to open if the driver has exited the vehicle and the change of mind timer has expired.

4. The electrified vehicle of claim 1, wherein the controller is further programmed to:
determine the driver is still in the vehicle after the ignition is keyed OFF;
identify a noise generating device that will begin a shutdown procedure that generates a device noise loud enough to mask the contactor noise; and
command the one or more contactors to open when the identified noise generating device generates the device noise, to thereby mask the contactor noise as perceived by the driver.

5. The electrified vehicle of claim 4, wherein the noise generating device is one of an electronic climate control (ECC), the entertainment module, and an instrument panel cluster.

6. An electrified vehicle comprising:
an electrified powertrain configured to generate drive torque;
a high voltage (HV) battery system for powering the electrified powertrain;
one or more contactors configured to selectively connect the HV battery system to a HV bus, the one or more contactors producing a contactor noise when opened to disconnect the HV battery system;
a noise generating device configured to, upon shut down, generate a device noise; and
a control system including a controller programmed to:
detect an ignition of the vehicle is keyed OFF;
initiate a contactor opening sequence including initiating a change of mind timer configured to provide a predetermined time period for a driver to change their mind about keying OFF the vehicle before the one or more contactors are commanded open;
determine the driver is still inside the vehicle after the ignition is keyed OFF; and
command the one or more contactors to open when the driver is still inside the vehicle, the change of mind timer has expired, and the noise generating device generates the device noise, to thereby mask the contactor noise as perceived by the driver.

7. The electrified vehicle of claim 6, wherein the contactor opening sequence is initiated only when the electrified vehicle does not require high voltage energy.

8. The electrified vehicle of claim 6, wherein the controller is further programmed to:
determine if the driver has exited the vehicle after the ignition is keyed OFF; and
command the one or more contactors to open if the driver has exited the vehicle and the change of mind timer has expired.

9. The electrified vehicle of claim 6, further comprising an entertainment module configured to generate audio sound, wherein the controller is further programmed to:
monitor the entertainment module to determine if the generated audio sound is louder than the contactor noise; and
command the one or more contactors to open if the generated audio sound is louder than the contactor noise and the change of mind timer has expired, to thereby mask the contactor noise as perceived by the driver.

10. The electrified vehicle of claim 6, wherein the noise generating device is one of an electronic climate control (ECC), the entertainment module, and an instrument panel cluster.

11. A method of reducing perceptible contactor noise generated by one or more contactors of an electrified vehicle having an electrified powertrain, a high voltage (HV) battery system selectively connected to a HV bus by the one or more contactors, and an entertainment module configured to generate audio sound, the method comprising:
detecting, by a controller, an ignition of the vehicle is keyed OFF;
initiating, by the controller, a contactor opening sequence including initiating a change of mind timer configured to provide a predetermined time period for a driver to change their mind about keying OFF the vehicle before the one or more contactors are commanded open;
monitoring, by the controller, the entertainment module to determine if the generated audio sound is louder than the contactor noise; and
commanding, by the controller, the one or more contactors to open if the generated audio sound is louder than the contactor noise and the change of mind timer has expired, to thereby mask the contactor noise as perceived by the driver.

12. The method of claim 11, wherein the contactor opening sequence is initiated only when the electrified vehicle does not require high voltage energy.

13. The method of claim 11, further comprising:
determining, by the controller, if the driver has exited the vehicle after the ignition is keyed OFF; and
commanding, by the controller, the one or more contactors to open if the driver has exited the vehicle and the change of mind timer has expired.

14. The method of claim 11, further comprising:
determining, by the controller, the driver is still in the vehicle after the ignition is keyed OFF;
identifying, by the controller, a noise generating device that will begin a shutdown procedure that generates a device noise loud enough to mask the contactor noise; and
commanding, by the controller, the one or more contactors to open when the identified noise generating device generates the device noise, to thereby mask the contactor noise as perceived by the driver.

15. The method of claim 14, wherein the noise generating device is one of an electronic climate control (ECC), the entertainment module, and an instrument panel cluster.
